(19) United States
(12) Patent Application Publication
(10) Pub. No.: US 2014/0159975 A1
(43) Pub. Date: Jun. 12, 2014

(54) WIDEBAND COMPACT DIPOLE MANPACK ANTENNA

(71) Applicant: AMI Research & Development, LLC, Windham, NH (US)

(72) Inventors: John T. Apostolos, Lyndeborough, NH (US); Brian Molen, Windham, NH (US); Benjamin McMahon, Nottingham, NH (US); William Mouyos, Windham, NH (US)

(73) Assignee: AMI Research & Development, LLC, Windham, NH (US)

(21) Appl. No.: 13/965,320

(22) Filed: Aug. 13, 2013

Related U.S. Application Data
(60) Provisional application No. 61/682,855, filed on Aug. 14, 2012.

(51) Int. Cl. H01Q 5/00; H01Q 9/28

(52) U.S. Cl. CPC H01Q 5/0017; H01Q 9/28
USPC 343/792

(57) ABSTRACT

An compact manpack format antenna operating over a broad bandwidth. In one arrangement, the antenna is formed from a set of five hollow cylindrical conductive elements. Several cylinders provide, for example, a VHF/UHF radiator section and other cylinders form an L-band radiator section. A bottom leg of the L-band section operates as part of the VHF/UHF section via coupling between that lower L-band leg and the VHF/UHF section. This coupling arrangement reduces the required overall physical length of the antenna.

### CROSS REFERENCE TO RELATED APPLICATIONS

This application claims the filing date benefit of and priority to a co-pending U.S. Provisional Patent Application Ser. No. 61/682,855 filed Aug. 14, 2012 and entitled “Wideband Compact Dipole Manpack Antenna”, the entire contents of which are hereby incorporated by reference.

### BACKGROUND

1. Technical Field

This disclosure relates to a wideband, compact dipole antenna for manpack applications.

2. Background Information

The ability to reliably communicate using wireless devices is important in many situations. Persons in almost all walks of life now commonly use mobile telephones and smartphone, for almost constant voice and data communications using different types of radio networks.

But other types of portable communication devices such as portable radios continue to be used for communication between personnel such as policemen, firemen, security guards, and soldiers. Such radios have included so-called manpack radios which are bulky and typically include a relatively large antenna. More recent advancements in radio communications technology have yielded much smaller portable radio communication devices known as handheld radios. These portable radio communication devices are convenient, but generally limited in longer range communication ability. This limitation is due in part to the poor efficiency associated with the type of antenna which is typically coupled thereto. In particular, conventional handheld radios commonly make use of a short flexible rubber coated antenna known a “whip” antenna. These antennas are usually vertical monopole designs which are made relatively short in length by means of electrical loading.

### SUMMARY

High quality, reliable communication requires antennas tailored for specific operating frequencies and bandwidths. It is therefore generally understood that for maximum performance, it is best to use different antennae each one specially engineered to operate in each specific band of interest. But it is increasingly desirable to provide an antenna design that can operate across a broad range of the electromagnetic spectrum and fit a single whip-type form factor.

Such an antenna would ideally provide operation across many of the popular communication bands ranging from Very High Frequency (VHF), to Ultra-High Frequency (UHF), to the so-called L-bands used for mobile telephone and digital wireless from about 900 Mhz to 2 GigaHertz.

The antenna should also be designed to fit a package that is intended to be easily carried by a single person, and therefore should also be as compact as possible, while still providing good performance for long range communications.

The wideband compact antenna design described here utilizes a unique approach to connecting different radiating sections and impedance matching at the lower frequencies which is transparent to operation at higher frequencies. The dipole configuration provides isolation between the wearer and the antenna which is not available for monopole configurations, eliminating the need for bulky ground plane structures.

In a specific embodiment, a number of cylindrical sections having conductive radiating surfaces are stacked and coaxially aligned with one another. Several of the cylinders form a VHF/UHF radiator section and other cylinders form an L-band radiator section.

A bottom leg of the L-band section operates as part of the VHF/UHF section due to coupling between that lower L-band leg and the VHF/UHF section. This coupling effect reduces the required overall physical length of the antenna.

These radiating cylindrical sections are advantageously coupled to a receiver and/or transmitter via connection(s) located at a common location at the bottom of the cylinder stack, such as near or within the center of the lowest one of the hollow cylindrical section(s).

Coaxial cables provide feeds from the transmitter and/or receiver connections and are disposed within the cylindrical sections.

The coaxial feeds are coupled to feed points located in or on the conductive surfaces of the cylindrical sections. In one arrangement, a VHF/UHF feed has a center conductor and an outer conductor, with the center conductor coupled to one of the VHF/UHF cylindrical sections and the outer conductor coupled to both (a) a feed point on one of the VHF/UHF cylindrical sections and (b) a feed point on one of the L-band type cylindrical sections. Also in this arrangement, an L-band feed has a center conductor and an outer conductor, the center conductor coupled to a feed point on one of the L-band cylindrical sections, and the outer conductor coupled to a feed point on one of the VHF/UHF cylindrical sections. The VHF/UHF feed point may therefore be a reverse feed.

A matching network, such as an resistor-inductor-capacitor (RLC) network, can be used to lower the voltage standing wave ratio (VSWR) without affecting performance at higher frequencies.

The L-band section does not require a matching network at frequencies below 800 MHz since coupling to the VHF/UHF section(s) increases the effective length of the assembly.

In optional arrangements a diplexer may be used to permit a single input transmission the point at the base.

The L-band section may include one or more pairs of additional cylindrical elements to improve performance; however this is at the expense of an additional 5 inches or more of length.

Suitable gain is achieved across a frequency range from 100 MHz to 2000 MHz in a compact dipole form factor without the use of meander lines.

### BRIEF DESCRIPTION OF THE DRAWINGS

The description below refers to the accompanying drawings, of which:

FIG. 1 is a high level schematic of the antenna assembly; and

FIGS. 2A and 2B illustrate measured gain.

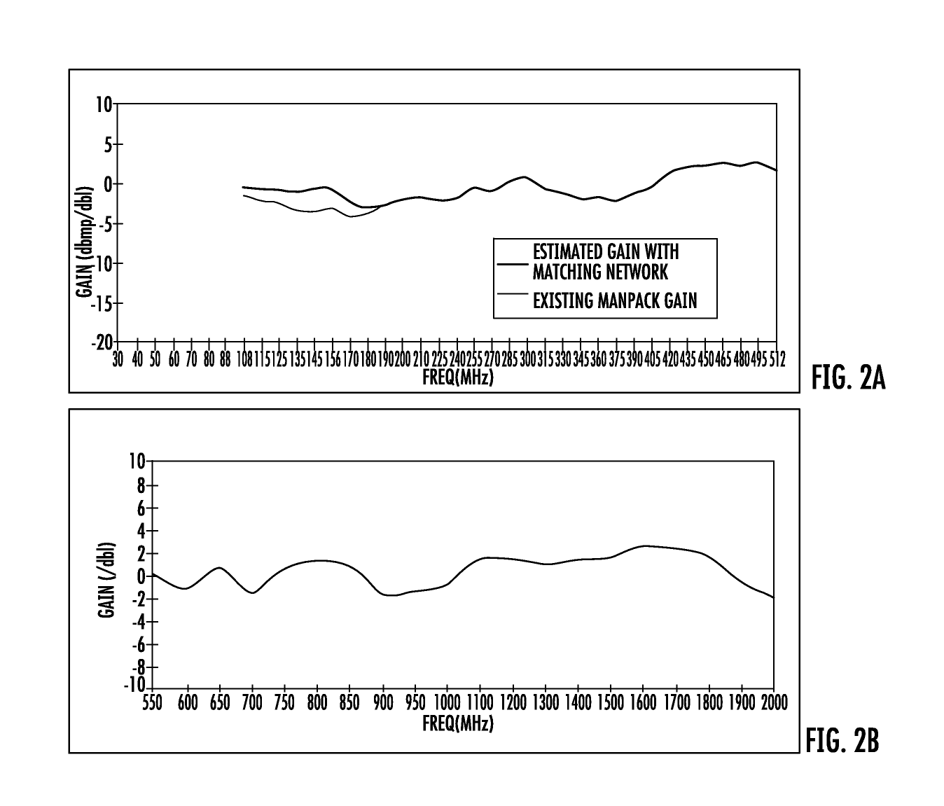

### DETAILED DESCRIPTION OF AN ILLUSTRATIVE EMBODIMENT

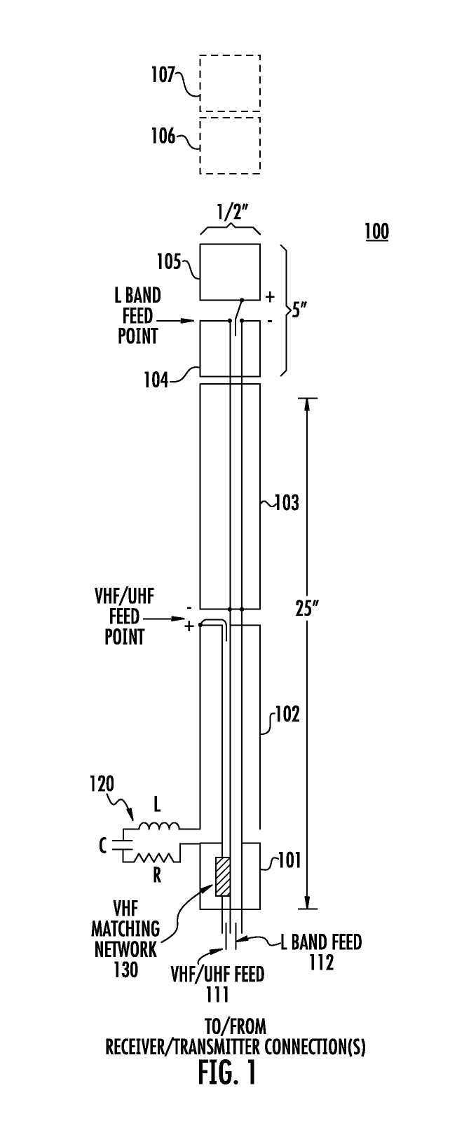

One design for a compact manpack antenna 100 operating from 100 MHz to 2000 MHz is shown in cross-section in FIG. 1. The antenna 100 is formed as an assembly of five cylindrical sections 101, 102, 103, 104, 105 coaxially arranged along a common axis. As the antenna 100 structure will typically be used in the vertical orientation with respect to the earth when operating, we will refer to the “lowest” section 101 being “below” section 102, and “upper” section 104 being “above” section 103, and so forth.

The cylindrical sections 101, 102, 103, 104, and 105 may be formed of metal or may be a dielectric having a conductive outer surface. As will be understood shortly, at least the lowest section 101 is hollowed out or has other accommodation for placing circuits within the cylinder.

The cylinders may be approximately ½ inch in diameter. The overall length of lower sections 101, 102, and 103 when taken together may be approximately 25 inches. The overall length of the two upper sections 104, 105 may be 5 inches.

In the embodiment shown, the lower three sections 101, 102, 103 operate primarily in a first frequency band or frequency bands, such as the VHF/UHF bands. The upper sections (section 104 plus the uppermost section 105) operate in a second frequency band, such as the L-band. Here, we refer to the radio bands with the VHF band including radio frequencies from about 30 MHz to 300 MHz, the UHF band including radio frequencies from about 300 MHz to 800 MHz and L-band frequencies in a range of about 800 MHz to 2 GHz.

Coaxial feeds are provided via coaxial cables located within the assembly. Two coaxial feeds, a VHF/UHF feed 111 and L-band feed 112 may be coupled to corresponding radio receiver inputs and/or radio transmitter outputs. The center conductors of the coaxial cables are only partially shown for the sake of clarity (that is, only the end portions of the center conductors are shown—the middle sections of the center conductors are left out of the drawing but are understood to exist).

The center conductor of the VHF/UHF feed 111 is terminated at an uppermost feed point of the upper VHF/UHF section 102. For example, this fed point can be a point that is adjacent the upper rim of the cylindrical section 102. The outer conductor of the VHF/UHF feed 111 is connected to a feed point located on the lower portion of section 103 (for example, on the lower rim of cylindrical section 103) as well as to a feed point on an uppermost portion of section 104 (for example, on the upper rim of cylindrical section 104). The inner conductor of the L-band feed 112 is provided to a feed point on the uppermost portion section 105 (for example, at the lower rim of cylindrical section 105); and the outer conductor is fed to a feed point on the lower portion (e.g., at the lower rim) of section 103 and the upper portion (e.g., at the upper rim) of section 104. It should be noted also that the lowermost section 101 is connected to the outer conductors of both the L-band 112 and VHF/UHF band 111 feeds.

The VHF/UHF feed can thus be referred to as a reverse feed because a typical vertical dipole has the inner conductor of a coaxial cable feeding the upper section on the dipole and the outer conductor of coaxial cable attached to the bottom section.

A unique feature of this antenna 100 is the ability to provide a good impedance match below 200 MHz without affecting the performance above 200 MHz.

The section operating in a frequency range from 512 to 2000 MHz utilizes a separate dipole mounted above the 100-512 MHz lower dipole section(s).

The reverse feed of the VHF/UHF section may include a resistor-inductor-capacitor (RLC) network 120 to be used to lower the Voltage Standing Wave Ratio (VSWR) without affecting performance above 200 MHz. The RLC network 120, which is tuned to resonate at about 150 MHz, is capacitive below 150 MHz, which helps to generally lower the VSWR and the resistor is used to further lower the VSWR to below 3. As a result, the RLC circuit tunes the VHF section below 150 MHz, and above 150 MHz or so, looks like an open circuit. For operation in the VHF/UHF bands, one arrangement has the inductor at typically 200 nanohenries, the resistor at 270 ohms, and the capacitor at typically 5 pf.

For a more general case of serving other pairs of frequency bands other than the VHF/UHF and L-bands, the RLC network should be tuned to resonate somewhere within the middle portion of the lower frequency band, and to look like an open circuit at least to the upper frequency band.

An optional high pass matching circuit 130 for 100 to 200 MHz may also be used to permit an even higher resistance in the RLC circuit 120, thus decreasing losses below 200 MHz. The high pass characteristic of the matching network 130 is such that operation above 200 MHz is transparent to the rest of the antenna 100.

The bottom leg 104 of the L-band antenna is also used as part of the VHF/UHF dipole because of the coupling between the L band antenna and the VHF/UHF antenna. This coupling effect reduces the overall length of the man pack antenna 100. The L band antenna does not require a matching network at frequencies below 800 MHz since the coupling to the VHF/UHF antenna section(s) increases the effective length of the L band antenna section(s).

A diplexer (not shown) may be included to permit using a single input transmission line to and from the receiver and/or transmitter.

The L band antenna may further include two additional elements 106, 107 if more gain is needed; but this is at the expense of an additional five inches of length. The additional elements 106, 107 are fed in the same way as elements 104, 105.

1. An antenna apparatus comprising:
at least five cylindrical sections disposed adjacent one another along a common axis, each cylindrical section having a conductive outer surface;
two or more of the cylindrical sections being a first type cylindrical section resonant within a first frequency band;
two of the cylindrical sections being a second type cylindrical section resonant within a second frequency band;
a first band feed having a center conductor and an outer conductor, the center conductor coupled to one of the first type cylindrical sections and the outer conductor coupled to both (a) a feed point on one of the first type cylindrical sections and (b) a feed point one of the second type cylindrical sections;
a second band feed having a center conductor and an outer conductor, the center conductor coupled to a feed point on one of the second type of cylindrical sections, and the outer conductor coupled to a feed point on one of the first type of cylindrical sections; and
a filter disposed between a selected one of the first type cylindrical sections and the first band feed.

2. The antenna of claim 1 further comprising:
an additional pair of second type cylindrical sections disposed adjacent the second type cylindrical sections; and
the second band feed having a center conductor also coupled to one of the additional pair of second type cylindrical sections.

3. The antenna of claim 1 wherein the first frequency band is lower in frequency than the second frequency band.

4. The antenna of claim 1 wherein the first frequency band includes a Very High Frequency (VHF) and an ultra-high frequency (UHF) band, and the second frequency band includes an L-band frequency band.

5. The apparatus of claim 1 further wherein all of the cylindrical sections are aligned with one another along a common vertically oriented axis.

6. The apparatus of claim 1 wherein the first type cylindrical sections are oriented below the second type cylindrical sections along the common vertically oriented axis.

7. The apparatus of claim 1 wherein the first band feed further comprises a center conductor terminated at an upper feed point of one of the first type cylinder sections, and an outer conductor terminated at a lower feed point on another one of the first type cylinder sections as well as to an upper feed point on one of the second type cylinder sections.

8. The apparatus of claim 1 wherein the second band feed further comprises a center conductor terminated at an upper feed point on one of the second type cylinder sections and an outer conductor terminated at a lower feed point on one of the first type cylinder sections.

9. The apparatus of claim 4 wherein the filter is a high pass filter tuned to operate as an open circuit above 200 MHz.

10. The apparatus of claim 9 additionally comprising:
a high pass matching circuit coupled to the first band feed.

11. An antenna comprising:
four or more cylindrical sections coaxially arranged along a common axis, the cylindrical sections each having a conductive outer surface;
two or more of the sections resonant in a VHF/UHF band;
one or more of the sections disposed above the VHF/UHF sections and resonant in an L-band;
a VHF/UHF feed having a center conductor terminated at an uppermost point of one of the VHF/UHF sections and an outer conductor connected to a lower portion of another VHD/UHF section as well as to an uppermost portion of one of the L-band sections;
an L-band feed 112 having a center conductor coupled to an uppermost L-band section and an outer conductor coupled to a lower portion of one of the VHF/UHF section; and
a resistor-inductor-capacitor (RLC) network coupled to one of the VHF/UHF sections.
